(19) United States
(12) Patent Application Publication
(10) Pub. No.: US 2002/0175193 A1
(43) Pub. Date: Nov. 28, 2002

(54) Golf car-mounted beverage dispenser

(76) Inventor: Michael W. Ballard, Port Orchard, WA (US)

Correspondence Address: Dean A.Craine, DEAN A. CRAINE, P.S., Suite 140, 400 I12th Avenue NE, Bellevue, WA, 98004-5542, US

(21) Appl. No.: 10/155,279

(22) Filed: May 24, 2002

Related U.S. Application Data
(60) Provisional application No. 60/293,529, filed on May 25, 2001.

(51) Int. Cl. A01C 1/00

(52) U.S. Cl. 222/608

(57) ABSTRACT

A golf car-mounted beverage dispenser designed to be used by golf course operators not only as a means for dispensing chilled beverages to its patrons, but also as a advertising medium. The beverage dispenser includes an inner half-cylindrical-shaped housing which is closed at one end and covered with a golf bag-simulating outer cover. Disposed longitudinally inside the housing is a cylindrical or square inner sleeve designed to receive a beverage tank filled with a desired beverage. The inner sleeve has a smaller diameter than the housing thereby creating an intermediate cavity between the housing and the inner sleeve for ice. Attached to the back of the housing is a mounting bracket for selectively attaching the housing to the support surface on a standard gas or electric powered golf car. Mounted on the sides of the housing is a second tank holding bracket used to hold a pressurized CO2 tank.

This is a utility patent application based on a provisional patent application (Serial No. 60/293,529) filed on May 25, 2001.

### BACKGROUND OF THE INVENTION

1. Field of the Invention

This invention pertains to chilled beverage dispensers, and in particular, to chilled beverage dispensers that simulate other decorative or functional items such as a golf bag.

2. Description of the Related Art

Because golfing is a social sport, played in warm weather, it is desirable to drink chilled beverages while playing. For this reason, backpacks with portable beverage dispensers specially marketed to golfers are well known.

Many golf course operators request that golfers refrain from eating or drinking on their courses because it slows down the game and creates litter. Because drinking is so popular, many golfers ignore these requests and carry cans or containers filled with a beverage in their golf bags.

One way to overcome the problem with unauthorized eating and drinking on the golf course is for golf course operators to construct concession stands in designated areas on the course. Unfortunately, such structures are expensive, use valuable land needed for playing, and distract from the overall beauty of the golf course.

What is needed is an apparatus that enables golf course operators to offer beverages to golfers in designated areas that does not require the construction of concession stands, does not use valuable land, and does not distract from the overall beauty. If the apparatus could also be used as an advertising medium for beverage or golf equipment venders, the cost of the apparatus could be offset by advertisers thereby making the use of the apparatus an income-generating tool for the golf course operator.

### SUMMARY OF THE INVENTION

It is an object of the present invention to provide a beverage dispenser mounted on a standard motorized golf car that can be used on the trails and pathways on a golf course.

It is another object of the present invention to provide such a beverage dispenser that can be used as an advertising medium for the golf course operator.

It is a further object of the present invention to provide such a beverage dispenser that is relatively inexpensive and simple to use.

These and other objects of the invention, which will become apparent, are met by a golf car-mounted beverage dispenser that includes an elongated, half-cylindrical, rigid housing which is closed at one end, a golf bag simulating outer cover disposed over the exposed curved surface of the housing, and a cylindrical or square inner sleeve disposed inside the housing which is slightly smaller in diameter than the housing thereby creating a space between the housing and the inner sleeve for ice. During use, a beverage tank filled with a desired beverage is placed inside the inner sleeve. Attached to the back, flat surface of the outer housing is a mounting bracket for selectively attaching the housing to a support surface on a golf car.

Connected to the beverage tank is a pressurized gas tank. The pressurized gas tank may be mounted on the sides of the housing with an optional second tank holding bracket. Or the pressurized gas tank may be disposed in a simulated side pocket on the outer cover. The outer cover includes a removable lid that simulates the top of a golf bag with optional heads of one or more golf clubs extending therefrom. Extending through the sidewalls of the housing and outer cover is a faucet, which connects to a beverage delivery hose connected at one end to the beverage tank. A gas pressure hose is also provided for connecting the pressurized gas tank to the beverage tank.

The beverage dispenser is mounted on a standard motorized golf car that is designed to be driven on standard size trails and pathways found on a golf course. Because the beverage dispenser simulates a real golf bag mounted on a motorized golf car, beverage or golf equipment companies would be highly interested in placing advertisements on the outer cover.

### BRIEF DESCRIPTION OF THE DRAWINGS

FIG. 1 is a perspective view of the golf car-mounted beverage dispenser attached to a golf car.

FIG. 2 is a perspective view of the invention.

FIG. 3 is a side elevational view of the invention.

FIG. 4 is a top plan view of the invention with the lid removed.

### DESCRIPTION OF THE PREFERRED EMBODIMENT(S)

Referring to the accompanying FIGS., there is shown and described an attractive, golf car-mounted beverage dispenser 10 mounted on a electrically powered golf car 75 that includes an elongated, half-cylindrical-shaped housing 20 closed at its lower end with a removable golf bag simulating outer cover 50. Disposed longitudinally inside the housing 20 is a cylindrical or square inner sleeve 30 designed to receive a beverage tank 34 filled with a desired beverage. The inner sleeve 30 has a smaller diameter than the housing 20 thereby creating an intermediate cavity 31 between the housing 20 and the inner sleeve 30 that is filled with ice 45. Attached to the backside of the housing 20 is a mounting bracket 70 for selectively attaching the housing 20 to the support surface 76 on a standard mobile golf car 75. Mounted on the sides of the housing 20 is a tank holding bracket 25 used to hold a small, pressurized CO2 tank 40.

The golf bag-simulating outer cover 50 is designed to cover the exposed front surfaces of the housing 20. The pressurized tank 40 is smaller than the beverage tank 34 and may be disposed in a simulated side pocket 55 on the outer cover 50. The outer cover 50 includes a removable lid 60 that simulates the top of a golf bag with the heads of one or more golf clubs 65 extending therefrom. Extending through the sidewall 22 of the housing 20 and outer cover 50 is a faucet 35 that connects to a beverage delivery hose 36 which is connected at one end to the beverage tank 34. An optional pressure hose 37 is also provided for connecting the pressurized CO2 tank 40 to the beverage tank 34. An optional drain 23 may be attached to the housing 20 or drain holes 24 may be formed on the bottom surface 26 of the housing 20.

The golf bag-simulating outer cover 50 includes a lower section 56 which is designed to fit completely around the outer housing 20. Both the lower section 56 and the lid 60 are made of vinyl or similar material and made to appear as a typical golf bag. The outer cover 50 may include optional actual or simulated outer pockets 55, snaps, traps, and zippers. The lower section 56 is a half cylindrical-shaped structure with top, bottom, and rear openings 51, 52, 53, respectively. Suitable connectors 54 may be provided along the edges of the lower section 56 adjacent to the top, bottom, and rear opening 51, 52, 53 that enable the lower section 56 to selectively attach to the curved outer housing 20.

The removable lid 60 is designed for fit over the top opening 51 of the curved surface of the lower section 56 to keep the inside cavity 31 filled with ice 45. The lid 60 is slightly larger in diameter than the upper portion of the lower section 56. It includes a central planar member 61 with cylindrical sidewalls 62. In the preferred embodiment, extended upward from the planar member 61 are optional simulated golf club heads 65 so that when the lid 60 is attached over the lower section 56, the outer cover 50 simulates a golf bag carrying a set of golf clubs. Optional connectors (not shown) may be provided to connect the lid 60 to the outer cover 50.

In the preferred embodiment, the housing 20 is an enclosed half-cylindrical-shaped structure with a bottom surface 26 and an open top opening 21. It is made of water resistant material, such as aluminum, and measures approximately 14 inches in width, 26½ inches in height, and 11 inches in depth. The inner sleeve 30 is cylindrical with top and bottom openings 32, 33 respectively, and measures approximately 9 inches in diameter and 23½ inches in height. The tank bracket 25 is U-shaped and designed to hold a cylindrical CO2 tank 40 measuring approximately 6 inches in diameter and 18 inches in height.

During use, a standard, motorized golf car 75 is selected and the mounting bracket 70 is attached to a planar surface 76 on the car 75. The housing 20 is then attached to the bracket 70. The pressurized CO2 tank 40 is then disposed in the tank holding bracket 25 and the beverage tank 34 is placed inside the housing 20. The beverage delivery hose 36 is connected to the beverage tank 34 and to the faucet 35. The pressure hose 37 is then connected to the CO2 tank 40 and the beverage tank 34. The outer cover 50 is then attached to the sides of the housing 20. The inner sleeve 30 is then placed around the beverage tank 34. Ice 45 is then placed in the intermediate cavity 31 between the inside surface of the housing 20 and the inner sleeve 30. The lower portion 56 and lid 61 are then placed around the housing 20.

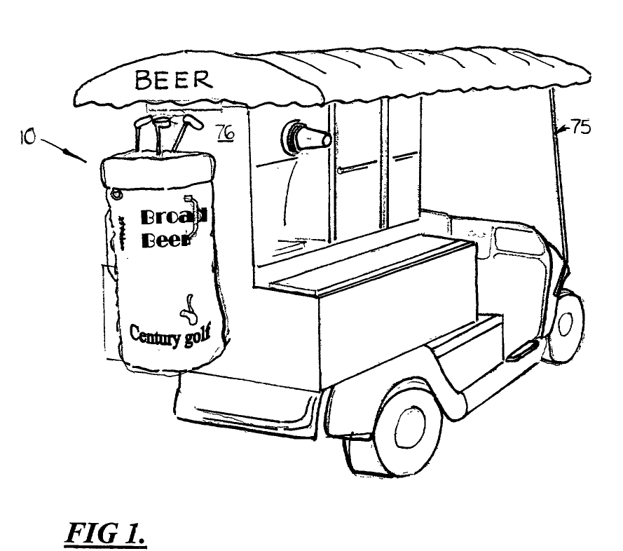

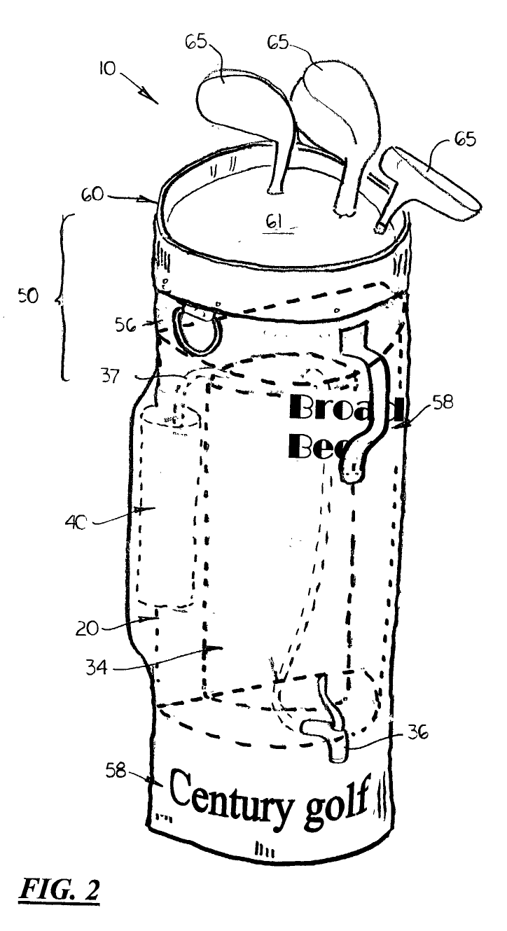

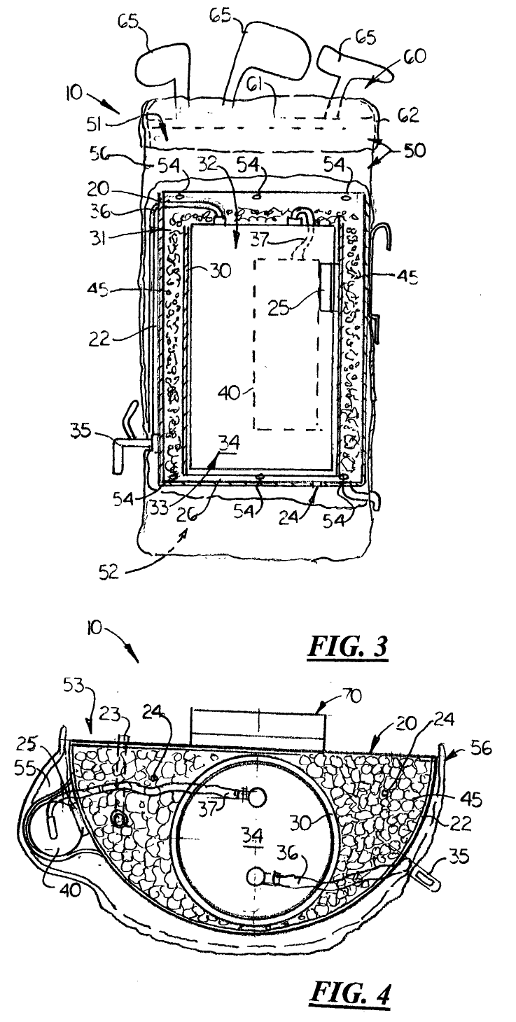

As shown in FIGS. 1 and 2, the front surface 57 of the lower portion 56 is designed to display advertising, generally denoted 58.

The golf car 75 may be gas or electric powered and designed for use on a golf course. Such cars have 10 to 13-inch wheels with a wheelbase of 72 to 84 inches and a width of 40 to 60 inches.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A golf car-mounted beverage dispenser, comprising:
a. a motorized golf car, said golf car having a support surface;
b. a beverage tank filled with a beverage;
c. a half-cylindrical-shaped housing for holding said beverage tank;
d. a removable inner sleeve member located within said housing capable of being placed around said beverage tank, said inner sleeve being smaller in diameter than said housing thereby creating an intermediate cavity between said housing and said inner sleeve;
e. a golf bag-simulating outer cover disposed over said housing, said outer cover including a removable lid;
f. a coolant located in said intermediate cavity; and,
g. means for attaching said housing to said support surface on said golf car.

2. The golf car-mounted beverage dispenser, as recited in claim 1, further including a pressurized gas tank.

3. The golf car-mounted beverage dispenser, as recited in claim 1, wherein said coolant is ice.

4. The golf car-mounted beverage dispenser, as recited in claim 3, further including a drain attached to said housing.
